(19) United States
(12) Patent Application Publication
(10) Pub. No.: US 2025/0373326 A1
(43) Pub. Date: Dec. 4, 2025

(54) Location based Protection of Satellite Communications from Interference Created by Cellular Communications

(71) Applicant: DISH Wireless L.L.C., Englewood, CO (US)

(72) Inventors: Mehdi ALASTI, Arlington, VA (US); Dhaval MEHTA, Aldie, VA (US); Siddhartha CHENUMOLU, Ashburn, VA (US)

(73) Assignee: DISH Wireless L.L.C., Englewood, CO (US)

(21) Appl. No.: 18/732,839

(22) Filed: Jun. 4, 2024

(51) Int. Cl. H04B 7/185

(52) U.S. Cl. CPC H04B 7/18547; H04B 7/18513; H04B 7/18532

(57) ABSTRACT

A method and system manage cellular communications considering satellite communications. The method includes determining an expected level of interference created by cellular communications for satellite communications for locations in a satellite coverage area. It also involves associating locations sets with interference mask and an associated restriction rule. The method further includes grouping the locations across the location sets based on a respective expected level of interference for a respective location. The system and method can be used to manage interference between cellular and satellite communications.

### FIELD

The present teachings pertain to the field of telecommunications, specifically to the management of interference in satellite communications created by cellular communications. The teachings use a model to analyze and identify sets of locations for a cell focusing on managing interference on satellite communication from cellular user equipment (UE) operating in the same frequency band.

### BACKGROUND

One of the challenges in satellite communication is the interference created by cellular User Equipment (UE) operating in the same frequency band, for example, to satellite uplinks. This interference can degrade the quality of the satellite and cellular communications, leading to data loss and reduced performance. The interference is particularly problematic in areas with high cellular UE density, where multiple devices are transmitting simultaneously. Furthermore, the interference can vary depending on the geographical location of the UEs and the satellite, making it difficult to manage and mitigate. Traditional methods of managing this interference have been largely static and do not take into account the dynamic nature of the problem. Therefore, there is a need for a system that can manage and mitigate this interference to ensure the integrity and reliability of satellite and cellular communications.

Previous approaches for managing interference between cellular and satellite communications have primarily focused on adjusting power levels, frequencies, or antenna configurations to mitigate interference. These approaches typically involve monitoring signal strength and quality metrics to dynamically adjust transmission parameters in real-time. However, these methods may not be effective in locations within a cell where the cellular and satellite interference is either magnified (for example, where there is a congested or always-on satellite channel) or is not created (for example, where a line-of-sight (LOS) between the satellite location and a satellite terminal is unavailable). As such, the traditional power control mechanisms fail to adequately address interference mitigation.

Additionally, some existing techniques involve frequency coordination between cellular and satellite systems to minimize interference. By allocating specific frequency bands to each system and implementing interference mitigation algorithms, these methods aim to reduce the impact of co-channel interference. However, these frequency coordination strategies may not be sufficient to address interference caused by specific user equipment (UE) locations within a cell that are in close proximity to satellite communication paths, especially when the satellite moves relative to the earth's surface.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a method for managing cellular communications in view of satellite communications, the method including: determining, for a satellite location, an expected level of interference created by cellular communications for satellite communications for locations in a satellite coverage area; associating locations sets with an interference mask and an associated restriction rule; grouping, for the satellite location, the locations across the location sets based on a respective expected level of interference for a respective location consistent with a respective associated interference mask for a respective location set; receiving cellular UE (user equipment) identifiers and associated coarse geolocations of UE disposed in a cell; distributing, when a satellite approaches the satellite location, each of the UE identifiers across the location sets when a respective geolocation is within a box defined by one of the locations in a respective location set; and scheduling a signal blanking for the distributed UE identifiers in each of the location sets based on a respective associated restriction rule for the respective location set.

In some aspects, the techniques described herein relate to a method, wherein one of the associated restriction rules includes inter-dependent restriction rules.

In some aspects, the techniques described herein relate to a method, wherein one of the interference mask includes an interference mask including frequency bands.

In some aspects, the techniques described herein relate to a method, further including subdividing one of the interference mask into a plurality of ranges; and decomposing each location set into a plurality of subdivided sets corresponding to the plurality of ranges.

In some aspects, the techniques described herein relate to a method, wherein the determining is performed for a plurality of frequency bands.

In some aspects, the techniques described herein relate to a method, further including simulating or measuring, for the satellite location, the expected level of interference at the locations.

In some aspects, the techniques described herein relate to a method, wherein the simulating or measuring uses an Artificial Intelligence/Machine Learning (AI/ML) classification model.

In some aspects, the techniques described herein relate to a method, wherein the simulating or measuring uses a computational model.

In some aspects, the techniques described herein relate to a method, wherein the receiving receives one of the geolocations from a respective one of the cellular UE.

In some aspects, the techniques described herein relate to a method, wherein the receiving receives one of the geolocations from a gNB (3GPP 5G Next Generation Node B).

In some aspects, the techniques described herein relate to a method, further including calculating the satellite location based on a satellite ephemeris data; and selecting the location set from a plurality of location sets based on the satellite location.

In some aspects, the techniques described herein relate to a method, wherein the signal blanking is performed using PRB (Physical Resource Block) blanking in a 5G (3GPP 5G Next Generation) radio network.

In some aspects, the techniques described herein relate to a method, wherein the satellite communications include an uplink from a satellite terminal disposed in the cell to a satellite at the satellite location, and the cellular communications includes an uplink from one of the cellular UE to a gNB.

In some aspects, the techniques described herein relate to a method, wherein the distributing is performed few seconds before a satellite arrival at the satellite location.

In some aspects, the techniques described herein relate to a method, wherein the locations and the satellite location are defined as a polygon.

In some aspects, the techniques described herein relate to a system to manage cellular communications in view of satellite communications, the system including: an interference analyzer to analyze, for a satellite location, an expected level of interference created by cellular communications for satellite communications for locations in a satellite coverage area; locations sets with interference mask and an associated restriction rule; a location set grouper to group, for the satellite location, the locations across the location sets based on a respective expected level of interference for a respective location consistent with a respective associated interference mask for a respective location set; a receiver to receive cellular UE (user equipment) identifiers and associated coarse geolocations of UE disposed in a cell; a location set distributor to distribute, when a satellite approaches the satellite location, each of the UE identifiers across the location sets when a respective geolocation is within a box defined by one of the locations in a respective location set; and a scheduler to schedule a signal blanking for the distributed UE identifiers in each of the location sets based on a respective associated restriction rule for the respective location set.

In some aspects, the techniques described herein relate to a system, the interference analyzer simulates or measures, for the satellite location, the expected level of interference at the locations using an Artificial Intelligence/Machine Learning (AI/ML) classification model.

In some aspects, the techniques described herein relate to a system, wherein the receiver receives one of the geolocations from a gNB (3GPP 5G Next Generation Node B).

In some aspects, the techniques described herein relate to a system, wherein the signal blanking is performed using PRB (Physical Resource Block) blanking in a 5G (3GPP 5G Next Generation) radio network.

In some aspects, the techniques described herein relate to a system, wherein the satellite communications include an uplink from a satellite terminal disposed in the cell to a satellite at the satellite location, and the cellular communications includes an uplink from one of the cellular UE to a gNB.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an embodiment of a hybrid cloud cellular network.

FIG. 2 illustrates an embodiment of a 5G Core.

FIG. 3 illustrates an embodiment of a hybrid cloud cellular network architecture.

FIG. 4A illustrates cellular and satellite coverage areas according to various embodiments.

FIG. 4B illustrates a system to manage interference created by cellular communications on satellite communications at various locations according to various embodiments.

FIG. 5 illustrates, in a flowchart, operations for managing satellite interference by scheduling User Equipment (UE) based on their location and interference levels.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### INTRODUCTION

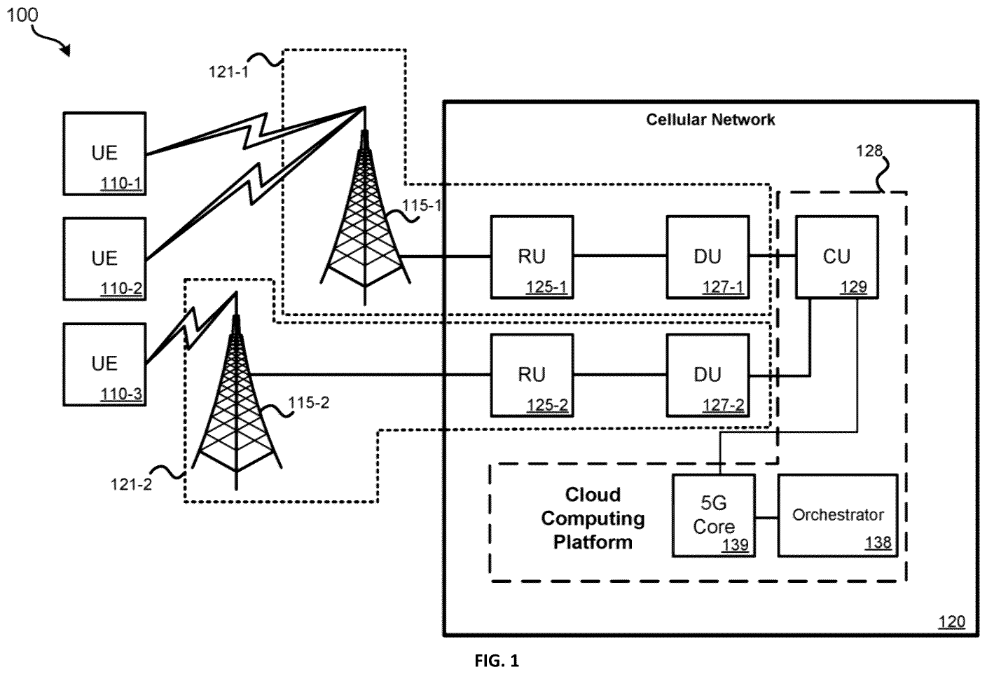

FIG. 1 illustrates a block diagram of a hybrid cellular network system (“system 100”). System 100 can include a 5G New Radio (NR) cellular network; other types of cellular networks, such as 6G, 7G, etc., may also be possible. System 100 can include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view. In an open radio access network (O-RAN), most components, except for components that need to receive and transmit RF, can be implemented as specialized software executed on general-purpose hardware or servers. For at least some components, the hardware may be maintained by a separate cloud-service computing platform provider. Therefore, the cellular network operator may operate some hardware (such as, RUs and local computing resources on which DUs are executed) connected with a cloud-computing platform on which other cellular network functions, such as the core and CUs are executed.

UE 110 can represent various types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE 110 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, or the like. Depending on the location of individual UEs, UE 110 may use RF to communicate with various BSs of cellular network 120. BS 121 may include an RU (e.g., RU 125-1) and a DU (e.g., DU 127-1). Two BSs 121 (BS 121-1 and BS 121-2) are illustrated. BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can reasonably be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 127-1, may communicate with CU 129. Collectively, an RU, DU, and CU create a gNodeB, which serves as the radio access network (RAN) of cellular network 120. DUs 127 and CU 129 can communicate with 5G core 139. The specific architecture of cellular network 120 can vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized implementation, CU 129, 5G core 139, and/or orchestrator 138 can be implemented virtually as software being executed by general-purpose computing equipment on a cloud-computing platform 128, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where 5G core 139 is executed, while other functions are executed at a separate server system or on a separate cloud computing system. In the illustrated embodiment of system 100, cloud-computing platform 128 can execute CU 129, 5G core 139, and orchestrator 138. The cloud-computing platform 128 can be a third-party cloud-based computing platform or a cloud-based computing platform operated by the same entity that operates the RAN. Cloud-based computing platform 128 may have the ability to devote additional hardware resources to cloud-based cellular network components or implement additional instances of such components when requested.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g. helm charts), creating Kubernetes nodes/pods, loading DU containers, configuring the DU, and activating other support functions (e.g. Prometheus, instances/connections to test tools). While this instantiation of a DU may be triggered by orchestrator 138, a chaos test system may introduce false DU container images in the repo, may introduce latency or memory issues in Kubernetes, may vary traffic messaging, and/or create other “chaos” in order to conduct the test. That is, chaos test system is not only connected to a DU, but is connected to all the layers and systems above and below a DU, as an example.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The traditional OSS/BSS stack exists above orchestrator 138. Chaos testing of these components, as well as other higher layer custom-built components. Such components can be required sources of information and agents for testing at the service/app/solution layer. One aim of chaos testing is to verify the business intent (service level objectives (SLOs) and SLAs) of the solution. Therefore, if we commit to a SLA with certain key performance indicators (KPIs), chaos testing can allow measuring of whether those KPIs are being met and assess resiliency of the system across all layers to meeting them.

A cellular network slice functions as a virtual network operating on an underlying physical cellular network. Operating on cellular network 120 is some number of cellular network slices, such as hundreds or thousands of network slices. Communication bandwidth and computing resources of the underlying physical network can be reserved for individual network slices, thus allowing the individual network slices to reliably meet defined SLA requirements. By controlling the location and amount of computing and communication resources allocated to a network slice, the QoS and QoE for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular parameters that can be set for a cellular network slice can include: uplink bandwidth per UE; downlink bandwidth per UE; aggregate uplink bandwidth for a client; aggregate downlink bandwidth for the client; maximum latency; access to particular services; and maximum permissible jitter.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include multiple defined slice layers. Each layer within a network slice may be used to define parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

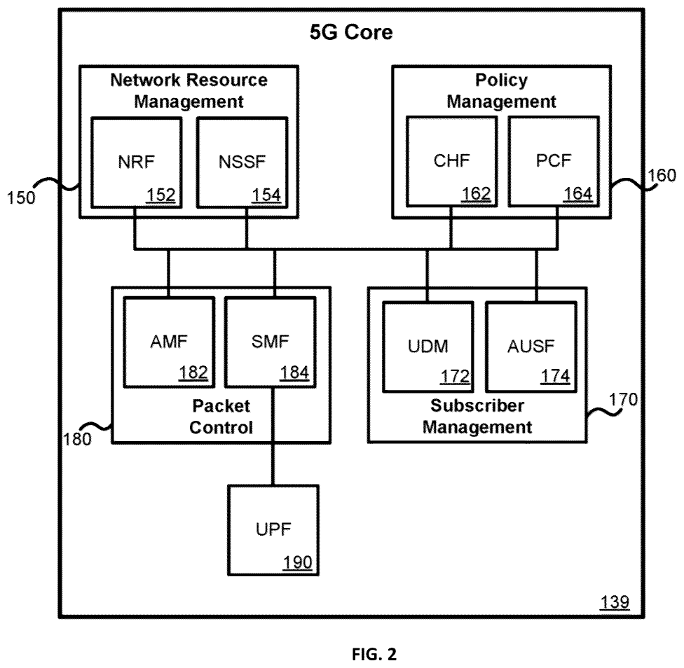

FIG. 2 illustrates a block diagram of a cellular network core, which can represent 5G core 139. 5G core 139 can be implemented on a cloud-computing platform. 5G core 139 can be physically distributed across data centers, or located at a central national data center (NDC), and can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1.

The functions illustrated in FIG. 2 as part of 5G core 139 are merely exemplary. Many more or different functions may be implemented in the cellular network core and may vary by slice. The amount of computing resources devoted to a particular function can vary by slice.

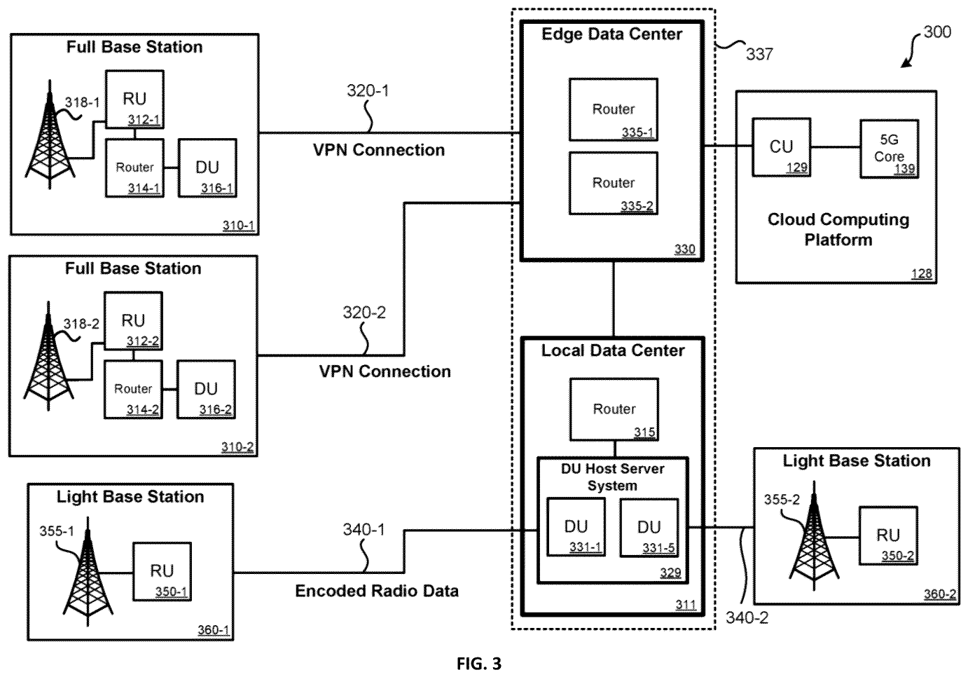

FIG. 3 illustrates an embodiment of hybrid cellular network system 300 (“system 300”) that includes hybrid use of local and remote DUs in communication with a cloud computing platform that hosts the cellular network core. System 300 can include: LDC 311; light BSs 360; full BSs 310; VLAN connections 320; edge data center 330 (“EDC 230”); CU 129; and 5G core 139, which are executed on cloud computing platform 128. In system 300, some base stations, referred to as “full base stations,” have DUs implemented locally at each BS. In contrast, a “light base station” includes structure (e.g., structures 355) and a local radio unit (e.g., RUs 350), but a DU implemented remotely at a geographically separated LDC. In system 300, either light BSs 360 or full BSs 310 may be referred to as a cell site.

LDC 311 can serve to host DU host server system 329, which can host multiple DUs 331 which are remote from corresponding light base stations 360. For example, DU 331-1 can perform the DU functionality for light base station 360-1. DUs with DU host server system 329 can communicate with each other as needed.

LDC 311 can be connected with EDC 330. In some embodiments, LDC 370 and EDC 330 may be co-located in a same data center or are relatively near each other, such as within 250 meters. EDC 330 can include multiple routers, such as routers 335, and can serve as a hub for multiple full BSs 310 and one or more LDCs 311. EDC 330 may be so named because it primarily handles the routing of data and does not host any RAN or cellular core functions. In a cloud-computing cellular network implementation at least some components, such as CU 129 and functions of 5G core 139, may be hosted on cloud computing platform 128. EDC 330 may serve as the past point over which the cellular network operator maintains physical control; higher-level functions of CU 129 and 5G core 139 can be executed in the cloud. In other embodiments, CU 129 and 5G core 139 may be hosted using hardware maintained by the cellular network provider, which may be in the same or a different data center from EDC 330.

Full BSs 310, which include on-site DUs 316, may connect with the cellular network through EDC 330. A full BS, such as full BS 310-1, can include: RU 312-1; router 314-1; DU 316-1; and structure 318-1. Router 314-1 may have a connection to a high bandwidth communication link with EDC 330. Router 314-1 may route data between DU 316-1 and EDC 330 and between DU 316-1 and RU 312-1. In some embodiments, RU 312-1 and one or more antennas are mounted to structure 318-1, while router 314-1 and DU 316-1 are housed at a base of structure 318-1. Full BS 310-2 functions similarly to full BS 310-1. While two full BSs 310 and two light BSs 360 are illustrated in FIG. 3, it should be understood that these numbers of BSs are merely for exemplary purposes; in other embodiments, the number of each type of BS may be greater or fewer.

While encoded radio data is transmitted via the fiber optic connections 340 between light BSs 360 and LDC 370, connection 320-1 between full BSs 310 and EDC 330 may occur over a fiber network. For example, while the connection between light BS 360-1 and LDC 370 can be understood as a dedicated point-to-point communication link on which addressing is not necessary, full BS 310-1 may operate on a fiber network on which addressing is required. Multiprotocol label switching (MPLS) segment routing (SR) may be used to perform routing over a network (e.g., fiber optic network) between full BS 310-1 and EDC 330. Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. Other full BSs may use the same types of communication link as full BS 310-1. While MPLS SR can be used for the network connection between full BSs 310 and EDC 330, it should be understood that other protocols and non-fiber-based networks can be used for connections 320.

For communications across connection 320-1, a virtual local area network (VLAN) may be established between DU 316-1 and EDC 330, when a fiber network that may also be used by other entities is used. The encryption of this VLAN helps ensure the security of the data transmitted over the fiber network.

Since light BSs 360 are relatively close to LDC 370, typically in a dense urban environment, use of a dedicated point-to-point fiber connection can be relatively straight-forward to install or obtain (e.g., from a network provider that has available dark fiber or fiber on which bandwidth can be reserved). However, in a less dense environment, where full BSs 310 can be used, a point-to-point fiber connection may be cost-prohibitive or otherwise unavailable. As such, the fiber network on which MPLS SR is performed and the VLAN connection is established can be used instead. Further, the total amount of upstream and/or downstream data from a light BS to an LDC may be significantly greater than the amount of upstream and/or downstream data from a DU of a full BS to EDC 337, thus requiring a dedicated fiber optic connection to satisfy the bandwidth requirements of light BSs.

To perform chaos testing, a small portion of the cellular network can be simulated and tested, followed by larger portions of the cellular network as needed to verify functionality and robustness. Once satisfied as to performance in a test environment, testing can be performed in a restricted production environment, followed by release into the general production environment. On each of these levels, some amount of chaos testing can be performed.

### Improvements

Location based protection of satellite communications from cellular communications may include a pre-analysis phase, a preparation phase and execution phase. Interference created by cellular communications depends on a satellite's location. Satellite communication typically depends on Line of Sight (LOS) availability. A LOS direction changes due to relative movement between a satellite and a location of a satellite terminal; the relative movement may be imparted due to satellite's movement relative to earth's surface and/or a movement of the satellite terminal. The LOS direction changes are thus primarily based on the satellite's location and changes in interference created by cellular communications on satellite communications are based on the LOS direction.

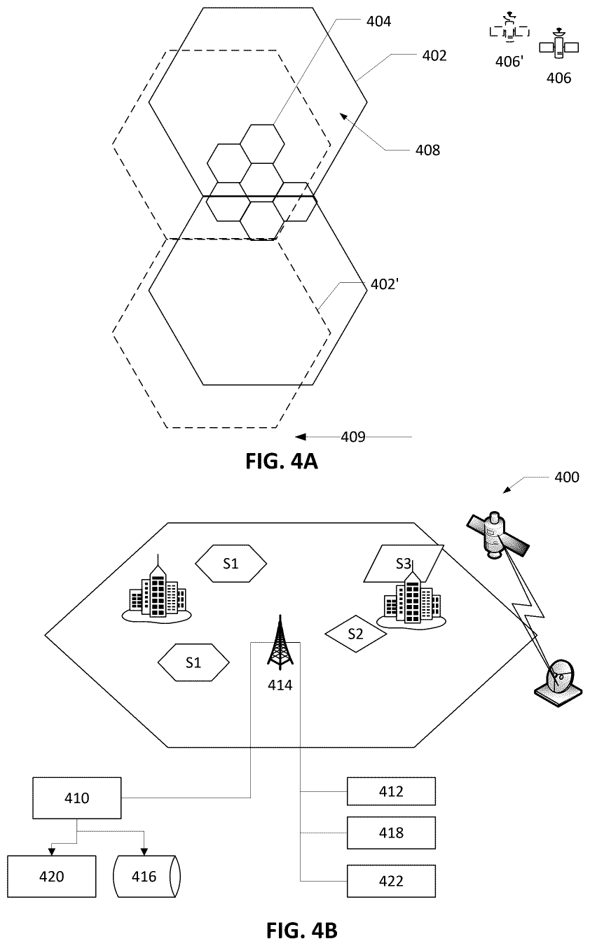

FIG. 4A illustrates cellular and satellite coverage areas according to various embodiments.

In FIG. 4A cells 404 illustrates a cellular communications coverage area of a cellular network provided by multiple base stations, for example, gNBs. Cells 404 are the smaller hexagons. Beam service areas (BSAs) 402 of a satellite at satellite location 406 used for satellite communications by a satellite network are shown as the larger hexagons. An arrow 409 indicates a direction of relative travel of the satellite location 406. Satellite coverage is per BSA 402 for satellite location 406 at a first instant, and per BSA 402′ for satellite location 406′ at a second instant after some time. As seen, BSA 402 covers different cells 404 than BSA 402′. In this example, cells 404 are assumed to be static coverage areas for cellular communications. Cells 404 may define the overlapping area, whereas portion 408 of BSA 402 may define a non-overlapping area. In some embodiments, a portion of cell 404 may not have overlapping communications service.

FIG. 4B illustrates a system to manage interference created by cellular communications on satellite communications at various locations according to various embodiments.

A system 400 to manage interference created by cellular communications on satellite communications at various locations may include an interference analyzer 410 to analyze and identify several sets of locations (X, Y, Z) for a BSA 402. Interference analyzer 410 may analyze overlapping coverage areas of cellular and satellite communications for interference. The analysis seeks to find overlapping locations where interference created by cellular communication on satellite communications is manageable depending on the satellite's location. The sets may be identified as “S1”, “S2”, . . . “SN”. Depending on a given location, Interference analyzer 410 may use simulation tools or measurements, for example, classification model 420, to calculate the amount of interference that various locations in an area having overlapping coverage by satellite and cellular communications. The level of interference is a quantifiable disruption caused by cellular signals to satellite signals, measured in terms of power over a specified frequency band (e.g., dBm/MHz).

Interference analyzer 410 may analyze several locations in the overlapping area to different sets “S1”, “S2”, . . . “SN” to identify the amount of interference cellular communications can create for the satellite communication given a satellite location. Different location sets may be analyzed and/or created for different satellite locations. Interference analyzer 410 may be part of a 5G core network. Interference analyzer 410 may provide access to location sets to an interference manager 414 and the like via a database 416. A satellite location calculator 418 may calculate the satellite location based on a satellite ephemeris data and selects the location sets from satellite location calculator 418 based on the satellite location.

Each of the location sets may be associated with an interference mask and an associated restriction rule. The associated restriction rules are linked with different levels of interference. The associated restriction rule may determine how much blanking a scheduler 412 uses to limit the interference created by the UEs disposed in locations of the location set. The interference mask may include a range of created interference that is manageable. The interference mask may include a frequency band associated with the range of created interference that is manageable. The interference mask may include one or more ranges and/or frequency bands. For example, location set “S1” may include all the locations where created interference is manageable with the associated restriction rule for the UEs disposed in locations of location set “S1”. Exemplary interference mask may be defined as PRB blanking of X when: Interference <“I” dBm/MHz for frequency range f1-f2, Interference <“J” dBm/MHz for frequency range f2-f3, or the like.

In some embodiments, the interference analyzer 410 may include or utilize an Artificial Intelligence/Machine Learning (AI/ML) classification model 420. The created interference in various locations of overlapping areas for a given satellite location is measured or simulated by the AI/ML model. The interference analyzer 410 may associate the respective various locations to populate the sets “S1”, “S2”, or the like based on their associated interference mask.

In some embodiments, the interference analyzer 410 may decompose The location sets into subsets depending on the amount of created interference. For instance, the set S1 can be split into subsets S11, S12, . . . . SIM with eight subset having one or more associated ranges and frequency bands. Each of the subsets can have associated restriction rules for the scheduler depending on the amount of created interference. For instance, the associated restriction rules may be defined such that if two UEs from S11 are scheduled, then only 2 UEs from S12 or 5 UEs from S13 can be scheduled. This will help scheduler 412 allocate bandwidth the UEs while minimizing the total created interference on the satellite.

The interference manager 414 may perform the preparation phase “T” seconds before the satellite is in the location for which interference mitigation must be effected. Interference manager 414 may be a sub-system of a gNB. Interference manager 414 may be deployed on a separate server. In the preparation phase, a scheduler 412, for example, a 5G Next Generation Node B (gNB), performs Physical Resource Blanking (PRB) blanking. Interference manager 414 may use a receiver 422 to obtain locations of UEs. From these locations, the interference manager 414 updates the list of UEs in sets “S1”, “S2”, . . . “SN”. The receiver 422 may identify a list of UEs prior to preparation phase based on one or more metrics, for example, CSI feedback/CQIs, beamforming, and analytics. Receiver 422 may perform UE identification in the areas of “S1”, “S2”, . . . “SN” based on positioning techniques in the UEs and/or a gNB.

In the Execution phase the scheduler 412 may manage the created interference based on the location of the satellite and the locations of the UEs in a cell. In some embodiments, only the UEs in the relevant locations of a location set will be scheduled for blanking.

The position of a UE may be determined using various techniques. In some embodiments, a User plane device base positioning may use a client APP on the UE may send SIP UPDATE or SIP OPTIONS message along with the PIDF-LO header with the UE's location.

In some embodiments, a Minimum drive test (MDT) can help to obtain the location of the UEs. An RRC measurement includes detailed location information for example, on GPS/GNSS coordinates. Not every UE may include an effective MDT implementation, for example, Rel-17 is most effective while there are some Rel-15 & Rel-16 UEs in the network. Also, GPS/GNSS is usually for outdoor cases.

In some embodiments. GMLC/LMF may be used on a UE to provide the UE's position. Currently, GMLC positioning is based on ID of a specific UE. GMLC uses LMF to obtain the location of these devices and through the API will report them to RAN/RIC.

In some embodiments, UE based positioning may use an over the top (OTT) client software on the devices to update the device's location, periodically or upon change.

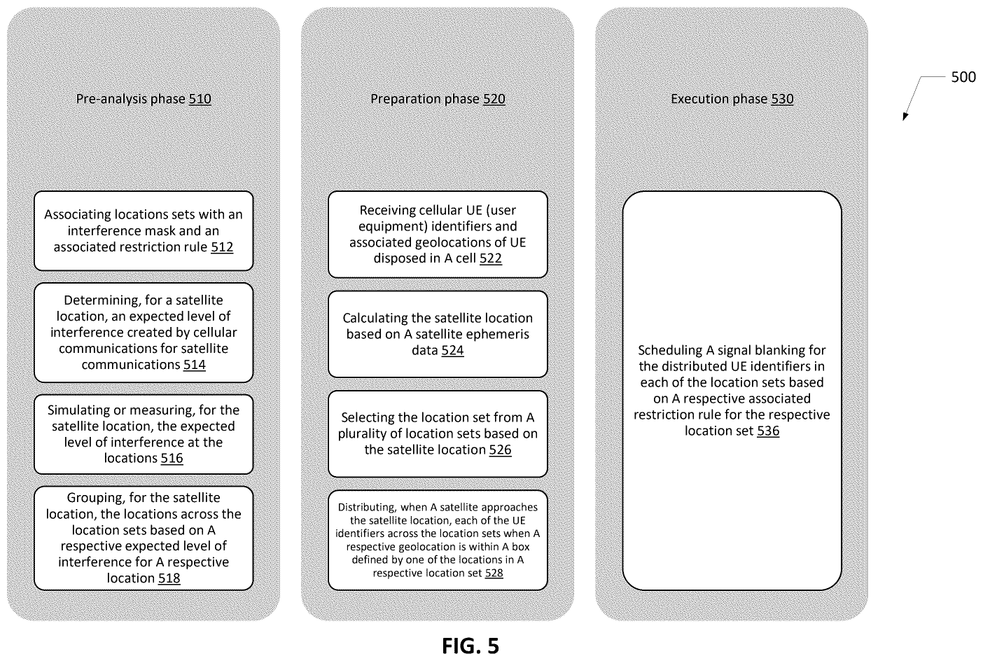

FIG. 5 illustrates, in a flowchart, operations for managing satellite interference by scheduling cellular User Equipment (UE) based on their location and interference levels, according to various embodiments.

A method 500 for managing interference in a cellular network to protect satellite communications may ensure that cellular user equipment (UE) communications within a cell do not adversely affect satellite communications operating in the same frequency band.

Method 500 includes a pre-analysis phase 510, a preparation phase 520 or an execution phase 530. Steps of phases may be moved from one phase to another in various embodiments.

Method 500 may include a pre-analysis phase 510 for analyzing and identifying sets of locations within a cell where the interference on satellite communications is manageable. This determination is based on a satellite's location when the interference is to be mitigated. The satellite's location may be calculated using satellite ephemeris data for the instant of interest. These actions involve the use of software tools and algorithms within the cellular network infrastructure to analyze, categorize, and manage the interference created by UEs. The goal is to ensure that satellite communications remain clear by strategically controlling the cellular links that share the same frequency band. This is achieved by scheduling PRB blanking for UEs in a way that adheres to the defined interference masks and restriction rules, thereby protecting the integrity of satellite uplinks.

At step 512, pre-analysis phase 510 may include associating locations sets with an interference mask and an associated restriction rule. Step 512 may include subdividing one of the interference mask into a plurality of ranges. This associating and subdividing allows for control and scheduling of UEs to minimize total interference where restriction rules for the scheduler are defined.

At step 514, pre-analysis phase 510 may include determining, for a satellite location, an expected level of interference created by cellular communications for satellite communications for locations in a satellite coverage area.

At step 516, pre-analysis phase 510 may include simulating or measuring, for the satellite location, the expected level of interference at the locations. Step 516 may include the application of an AI/ML classification model to measure or simulate interference over frequency caused by devices across a geographical area. The AI/ML classification model includes the following:
Data Collection: The AI/ML model requires a dataset that includes interference levels from devices throughout the geographical area. This data can be obtained through measurements using sensors or through simulations that model device behavior and their impact on satellite communications.
Model Training: The collected data is used to train the AI/ML model. The model learns to predict interference levels based on location characteristics, such as proximity to the satellite, device density, blockages (buildings, trees or the like) within a LOS of a satellite and a satellite terminal) and other relevant factors.
Classification: Once trained, the AI/ML model can classify new locations, determining the interference a UE in a particular location is likely to cause. This classification is based on patterns learned from the training data.

In step 516, the assumption is that the AI/ML model has been adequately trained and validated to predict interference levels accurately. The geographical area is well-defined, and the characteristics of the devices and their operating environment are known for accurate simulation or measurement. The interference thresholds or masks are predefined and are part of the model's output structure, which directly informs the management strategies.

At step 518, pre-analysis phase 510 may include grouping, for the satellite location, the locations across the location sets based on a respective expected level of interference for a respective location consistent with a respective associated interference mask for a respective location set. This grouping or association organizes locations into groups for interference mitigation. The output of step 516 is used to group or associate each location with a specific set (e.g., “S1”, “S2”). These sets are defined by the expected interference levels, with each set corresponding to a different interference threshold or mask. The sets are used to implement strategies, such as scheduling signal blanking (Step 536) to minimize the impact on satellite communications.

Method 500 includes a preparation phase 520 for calculating a satellite's location and retrieving associated locations sets and locations of UEs. In some embodiments, preparation phase 520 includes the procedures taken by the gNB to prepare for the satellite's approach by identifying UEs and updating their distribution based on geolocations of the identified UEs and potential interference levels. This preparation ensures that PRB blanking can be scheduled to mitigate interference with satellite communications. In some embodiments, preparation phase 520 is done seconds before the satellite's arrival to ensure that the interference is managed during the time when the satellite is within the coverage area of the cell, for example, about 10 seconds before, about 20 seconds before, about 60 seconds before, or the like. The association of a UE to locations of a location set may be based on a coarse geolocation of a respective UE. In some embodiments, the coarse geolocation of UE might be sufficient, for example, within 50 meters, 100 meters, 500 meters or the like, of an actual geolocation. Finer or more accurate geolocations of the UEs correlates to more effective scheduling of PRB blanking.

At step 522, preparation phase 520 may include receiving cellular UE (user equipment) identifiers and associated geolocations of UE disposed in a cell. Step 522 encompasses the techniques used to ascertain the geolocation of UEs within a cell. These techniques can include User plane device base positioning, Minimum drive test (MDT), GMLC/LMF, or over the top (OTT) client software.

At step 524, preparation phase 520 may include calculating the satellite location based on a satellite ephemeris data.

At step 526, preparation phase 520 may include selecting the location set from a plurality of location sets based on the satellite location.

At step 534, preparation phase 520 may include distributing, when a satellite approaches the satellite location, each of the UE identifiers across the location sets when a respective geolocation is within a box defined by one of the locations in a respective location set.

Method 500 includes execution phase 530 for scheduling UEs being serviced by a cell and managing the interference created.

At step 536, execution phase 530 may include scheduling a signal blanking for the distributed UE identifiers in each of the location sets based on a respective associated restriction rule for the respective location set. The rules for the scheduler are tailored to the acceptable level of interference for satellite communications. These rules guide the scheduler in allocating transmission opportunities to user equipment (UE) within a cellular network. The rules might specify, for instance, that if two UEs from subset S11 are scheduled, then only a limited number of UEs from another subset S12 or S13 can be scheduled, keeping the total interference within specified limits.

Scheduling UEs may use Physical Resource Blanking (PRB) blanking for user equipment (UE) identifiers within a cell based on their geolocation and the satellite's location. PRB blanking involves deactivating certain physical resource blocks in the cellular network to reduce interference with the satellite uplink. This scheduling is based on the geolocation of UEs and their distribution across the location sets.

In some embodiments, the 5G Next Generation Node B (gNB) orchestrates the timing and allocation of Physical Resource Blocks (PRBs) for UEs. The gNB utilizes predefined restriction rules associated with location sets to determine which UEs should have their signals temporarily disabled to reduce interference with satellite communications.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for managing cellular communications in view of satellite communications, the method comprising:
determining, for a satellite location, an expected level of interference created by cellular communications for satellite communications for locations in a satellite coverage area;
associating locations sets with an interference mask and an associated restriction rule;
grouping, for the satellite location, the locations across the location sets based on a respective expected level of interference for a respective location consistent with a respective associated interference mask for a respective location set;
receiving cellular UE (user equipment) identifiers and associated coarse geolocations of UE disposed in a cell;
distributing, when a satellite approaches the satellite location, each of the UE identifiers across the location sets when a respective geolocation is within a box defined by one of the locations in a respective location set; and
scheduling a signal blanking for the distributed UE identifiers in each of the location sets based on a respective associated restriction rule for the respective location set.

2. The method of claim 1, wherein one of the associated restriction rules comprises inter-dependent restriction rules.

3. The method of claim 1, wherein one of the interference mask comprises an interference mask comprising frequency bands.

4. The method of claim 1, further comprising subdividing one of the interference mask into a plurality of ranges; and decomposing each location set into a plurality of subdivided sets corresponding to the plurality of ranges.

5. The method of claim 1, wherein the determining is performed for a plurality of frequency bands.

6. The method of claim 1, further comprising simulating or measuring, for the satellite location, the expected level of interference at the locations.

7. The method of claim 6, wherein the simulating or measuring uses an Artificial Intelligence/Machine Learning (AI/ML) classification model.

8. The method of claim 6, wherein the simulating or measuring uses a computational model.

9. The method of claim 1, wherein the receiving receives one of the geolocations from a respective one of the cellular UE.

10. The method of claim 1, wherein the receiving receives one of the geolocations from a gNB (3GPP 5G Next Generation Node B).

11. The method of claim 1, further comprising calculating the satellite location based on a satellite ephemeris data; and selecting the location set from a plurality of location sets based on the satellite location.

12. The method of claim 1, wherein the signal blanking is performed using PRB (Physical Resource Block) blanking in a 5G (3GPP 5G Next Generation) radio network.

13. The method of claim 1, wherein the satellite communications comprise an uplink from a satellite terminal disposed in the cell to a satellite at the satellite location, and the cellular communications comprises an uplink from one of the cellular UE to a gNB.

14. The method of claim 1, wherein the distributing is performed few seconds before a satellite arrival at the satellite location.

15. The method of claim 1, wherein the locations and the satellite location are defined as a polygon.

16. A system to manage cellular communications in view of satellite communications, the system comprising:
an interference analyzer to analyze, for a satellite location, an expected level of interference created by cellular communications for satellite communications for locations in a satellite coverage area;
locations sets with interference mask and an associated restriction rule;
a location set grouper to group, for the satellite location, the locations across the location sets based on a respective expected level of interference for a respective location consistent with a respective associated interference mask for a respective location set;
a receiver to receive cellular UE (user equipment) identifiers and associated coarse geolocations of UE disposed in a cell;
a location set distributor to distribute, when a satellite approaches the satellite location, each of the UE identifiers across the location sets when a respective geolocation is within a box defined by one of the locations in a respective location set; and
a scheduler to schedule a signal blanking for the distributed UE identifiers in each of the location sets based on a respective associated restriction rule for the respective location set.

17. The system of claim 16, the interference analyzer simulates or measures, for the satellite location, the expected level of interference at the locations using an Artificial Intelligence/Machine Learning (AI/ML) classification model.

18. The system of claim 16, wherein the receiver receives one of the geolocations from a gNB (3GPP 5G Next Generation Node B).

19. The system of claim 16, wherein the signal blanking is performed using PRB (Physical Resource Block) blanking in a 5G (3GPP 5G Next Generation) radio network.

20. The system of claim 16, wherein the satellite communications comprise an uplink from a satellite terminal disposed in the cell to a satellite at the satellite location, and the cellular communications comprises an uplink from one of the cellular UE to a gNB.
